(19) United States
(12) Patent Application Publication
(10) Pub. No.: US 2003/0004780 A1
(43) Pub. Date: Jan. 2, 2003

(54) Method and system for integrating weather information with enterprise planning systems

(76) Inventors: Michael R. Smith, Wichita, KS (US); Roger A. Pielke JR., Boulder, CO (US)

Correspondence Address: BANNER & WITCOFF, 1001 G STREET N W, SUITE 1100, WASHINGTON, DC, 20001, US

(21) Appl. No.: 09/883,340

(22) Filed: Jun. 19, 2001

(51) Int. Cl. G06F 17/60; G06F 7/00; G06F 17/00

(52) U.S. Cl. 705/10; 707/104.1

(57) ABSTRACT

A method and system for integrating weather information into enterprise systems is disclosed. A weather module compares and relates meteorological variables to decision information, including critical threshold levels, specific to individual business processes represented in enterprise systems. A probability may be associated with each critical threshold level in order for the weather module to determine whether the likelihood that a critical threshold level will be exceeded meets or exceeds its associated probability. The weather module may then send results to the enterprise system indicating that a critical threshold has been exceeded, or that there is a likelihood that a critical threshold may be exceeded within a future forecast time horizon. The weather module may also maintain a historical weather database that the enterprise system can query in order to obtain historical weather information relevant to business decisions.

### FIELD OF THE INVENTION

The present invention relates in general to the field of computer systems, and more particularly to a method and system for integrating weather information with enterprise planning systems.

### BACKGROUND OF THE INVENTION

Computer-based planning systems are utilized in various industries to plan operations of an enterprise. Such systems include, but are not limited to Enterprise Resource (or Requirements) Planning (ERP), Materials Resource (or Requirements) Planning (MRP), and Distribution Resources (or Requirements) Planning (DRP) systems, collectively referred to herein as enterprise planning systems. Some examples of companies that produce enterprise planning systems include Peoplesoft, SAP, i2, Oracle, and the like. Such systems typically consist of computer software modules that represent key processes of a business. When such modules are linked together and share information, the resulting system provides its users with an integrated, and in some cases comprehensive, approach for managing a business. One typical mechanism for information exchange in such systems is Electronic Data Interchange (EDI).

Enterprise operations for which planning systems are used include, but are not limited to: production planning, supply chain management (both buying and selling), inventory management, vendor management, customer relationship management, order tracking and fulfillment, human resources, service call scheduling, accounting, etc. In simple terms, an enterprise system provides enterprises with an integrated view of the important component processes that together represent their operations. Such a view allows businesses to manage and optimize various complex operations of an enterprise and its relationships with other enterprises, e.g., such as through a supply chain.

Many businesses are sensitive to the impacts of weather and related phenomena. According to the U.S. Bureau of Economic Analysis, 42% of the $9 trillion U.S. economy has some sensitivity to weather. Such sensitivities range from the impacts of extreme weather on operations, (e.g., wind-storm caused train derailments or thunderstorm-related airline flight delays), to more routine impacts (e.g., temperature fluctuations that drive electrical power demand or precipitation effects on agricultural production).

Because of the impacts of weather on business, a commercial meteorology market has developed that provides weather information to businesses. Some businesses maintain in-house meteorological or related expertise. But the vast majority of companies that are in some way sensitive to weather neither contract the services of commercial meteorologists nor do they have in-house meteorological or related expertise. Even companies that rely on meteorological data to help plan their business do so on an ad hoc basis; that is, such data is not integrated into existing ERP systems, e.g., in such a way that would allow for an integrated perspective of the effects of weather on key business process, or in such a way that enterprise decisions can be made automatically by computer. For example, even if it is known that a severe ice storm will hit an area and will likely cause damage to power lines, there is no automated way of considering weather information in planning systems that would enable proactive notifying and scheduling of resources to react to damage before it occurs.

U.S. Pat. No. 5,832,456 (the '456 patent), issued Nov. 3, 1998 to Fox et al., discloses a system and method for forecasting future retail performance based on a sales history database, a weather history database, and a weather forecast database. An analyzer determines the extent to which past retail performance of products at a plurality of locations was affected by weather using the history databases. A configurator uses the results from the analyzer, in conjunction with the weather forecast database, in order to estimate expected future retail performance of the products at the stores for future time periods. The system in the '456 patent does not take into account weather forecasts for the immediate future, nor does it incorporate weather forecasts into an enterprise system used for making business decisions. Instead, the '456 system and method only use historical information and broad future weather forecasts to make predictions of future retail sales.

Because enterprise systems are designed to provide decision makers in business with a comprehensive view of information relevant to effective business operations, such systems are uniquely capable of integrating weather information with business process information. To date, no one has developed a method or system for integrating real time and historical weather information into decision processes in business process decision systems, such that the business process decision system is capable of integrating weather information with other information relevant to business processes or making business decisions based on short-term weather forecasts as well as on general weather trends.

### SUMMARY OF THE INVENTION

The present invention provides a mechanism for weather information to be integrated into enterprise systems via a data exchange interface that relates meteorological variables to decision relevant information specific to individual business processes. Various embodiments of the present invention contemplate integrating into enterprise systems meteorological, climatological and related information on any time or space scale with any business process that is in some way sensitive to weather.

Weather information is provided in terms of variables describing phenomena (temperature, precipitation, etc.) on various time and spatial scales, with accuracy that may be known reliably in some but not all cases.

The ability to systematically integrate weather information into enterprise planning, and thus translate meteorological variables into relevant business process information is a technical advantage of the present invention. The electronic interchange of the present invention allows weather information to be systematically considered and evaluated in the context of the extended enterprise planning environment as represented by the enterprise planning system. This stands in contrast to the typical situation where weather information is considered outside the context of the enterprise planning system, reducing the potential value of both the weather information and the integrated perspective provided by the enterprise planning system. The electronic interchange can be implemented for enterprise systems that consider only particular aspects of enterprise operations (e.g., supply chain planning) or integrated aspects of enterprise planning (e.g., integrated supply chain and human resources planning).

### A BRIEF DESCRIPTION OF THE DRAWINGS

A more complete understanding of the present invention and the advantages thereof may be acquired by referring to the following description in consideration of the accompanying drawings, in which like reference numbers indicate like features and wherein:

FIG. 1 is a block diagram of an embodiment of a system for integrating weather information with an enterprise planning system according to the teachings of the present invention;

FIG. 2 is a data flow diagram of an embodiment of a system for integrating weather information with an enterprise planning system according to the teachings of the present invention; and

FIG. 3 is a flowchart of an embodiment of a system for integrating weather information with an enterprise planning system according to the teachings of the present invention.

FIG. 4 is an example network architecture that may be used with an embodiment of a system for integrating weather information with an enterprise planning system according to the teachings of the present invention.

FIG. 5 is a second example of an architecture that may be used with an embodiment of a system for integrating weather information with an enterprise planning system according to the teachings of the present invention, including data flow indications.

### DETAILED DESCRIPTION OF THE INVENTION

According to the teachings of the present invention, a weather software module acts on information provided by various weather information providers and enterprise systems. The weather module may provide information relevant to component business processes of the enterprise system(s) based on meteorological and climatological information. Meteorological information generally refers to predictive or recent weather information, while climatological information generally refers to historical weather information.

At least five general concepts may be considered when integrating weather information in enterprise planning. The first concept is comprehensive perspective. Enterprise systems seek to provide organizations with a view of operations that is integrated from the standpoint of important influences. For operations that are influenced by weather, enterprise systems that incorporate this influence may better provide a true comprehensive perspective. However, enterprise systems may also be specialized in nature, depending on an organization's needs. Weather information can be highly relevant to such specialized planning systems as well (e.g., in supply chain management).

A second concept is procedural rationality. Businesses require solutions that, when implemented, will have intended effects. Procedurally rational behavior is enhanced when relevant information of the planning context is incorporated into the planning process. For companies with sensitivities to weather, weather information is part of this context.

A third concept is predictability. For many years weather was considered an “act of God” and thus a cost of doing business. Scientific and technological advances in the fields of meteorological observations, modeling, forecasting, and use of information have resulted in informational products of known accuracy to various degrees. Such informational products range in time scales from the immediate present to years in advance and from spatial scales from a particular point to continents across the globe. Advances in predictability provide the potential for businesses to proactively mange their sensitivities to weather.

A fourth concept is advanced warning. When a change in the context of business operations occurs, whether motivated by an actual extreme event such as a tornado or a forecast of conditions that are expected to influence business operations, a system can relay this information to relevant business processes across and outside of an enterprise. The availability of advanced warning in the context of an integrated system therefore allows for more effective decision making within organizations.

A fifth concept is business optimization. Just as business scenarios change frequently, so too do weather and climate scenarios (e.g., predictions for next year's hurricane activity). The present invention provides a means for incorporating such information into business planning in a way that will enhance the recommendation of operational solutions that can maximize quantifiable business objectives such as revenue and profit, and minimize loss of revenue and costs. It should be obvious to one of skill in the art that other factors may also be used when integrating weather information into an enterprise system, and that not all of the above concepts are necessarily present in all embodiments.

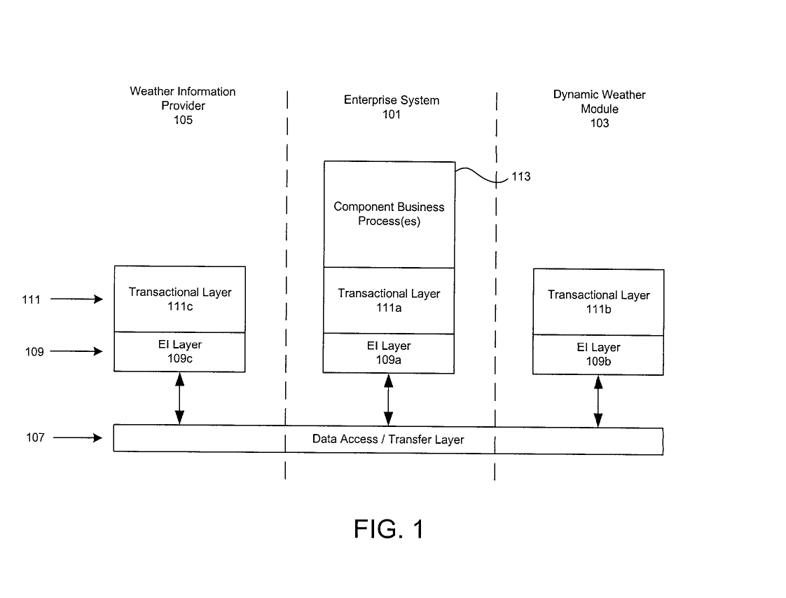

FIG. 1 is a block diagram of one embodiment of a system for integrating weather information with an enterprise system according to the teachings of the present invention. FIG. 1 shows an enterprise system 101, a weather module 103, and weather information provider 105. An enterprise system may be any data processing system that integrates business processes within an enterprise (or across enterprises) or automates business process decisions. The enterprise system may have one or more computer-implemented component business processes 113 which are sensitive to the effects of weather. An example of a component business process sensitive to the effects of weather is an airplane flight routing system. That is, the cities through which an airline routes flights may depend on the weather in each possible routing city. The airline may want to route flights through cities with the least likelihood of being affected by inclement weather. Another example is a repair crew scheduling system for an electric utility. A severe storm may necessitate the rapid scheduling of repair crews to power lines damaged by a storm. Other component business processes may easily be envisioned by those skilled in the art, depending on business and consumer needs.

It should be understood that some or all components of an enterprise system may have sensitivity to weather, and that if some components have sensitivity, any integration of these processes by the enterprise system into other processes may also reflect that sensitivity. It should also be understood that the present invention contemplates the possibility of more than one weather information provider 105, providing complementary (e.g., temperature and precipitation forecasts for the same location) or redundant information (e.g., multiple temperature forecasts for the same location). It should also be understood that the present invention contemplates more than one enterprise planning system 101 possibly belonging to non-related enterprises. However, FIG. 1 shows only one weather information provider 105 and one enterprise planning system 101.

The architecture shown in FIG. 1 includes a transactional layer 111, an electronic interchange (EI) layer 109, and a data access and transfer layer 107. The transactional layer performs calculations and data manipulation incident to the function of each module. The EI layer packs or unpacks sent and/or received data. Finally, the data access and transfer layer 107 handles the physical transfer of the data in the architecture.

For instance, the transactional layer 111c in the weather information provider 105 assembles the weather information from the weather information provider. The EI layer 109c then packages the information and sends it over the data access and transfer layer 107 to the weather module 103. The EI layer 109b in the weather module unpacks the data and communicates it to the transactional layer 111b, where the data is manipulated according the invention as herein described. After the weather module has performed its calculations, the manipulated and resultant data is communicated back to the EI layer 109b, where it is packed and sent via data layer 107 to the enterprise system 101 for further use according to the invention.

Each electronic interchange layer 109a, 109b, and 109c is in communication with its associated transactional layer, 111a, 111b, and 111c, respectively. Transactional layer 111b and EI layer 109b may comprise software executing on a computer system that may be part of the enterprise system 101 or it may be implemented on a separate server. Similarly, transactional layer 111c and EI layer 109c may comprise software executing on a computer system located at the weather information provider 105. While the layers provide an interface that allows receipt of information, the same functions may be performed by software modules or hardware architectures not arranged as distinct layers. The point of a “layer” is to assure successful data interchange as a separate function from data manipulation. The architecture described herein is merely one architecture that may be used in accordance with the invention. For instance, data layer 107 may comprise a computer network of various types.

In one embodiment of the present invention data access/transfer layer 107 uses the public Internet or a private intranet as a means of communication. In another embodiment of the present invention data layer 107 is implemented using a private LAN or WAN network. Data access/transfer layer 107 may be implemented using protocols such as TCP/IP, Ethernet, or others. It should be noted that there are other ways to implement a data access/transfer layer.

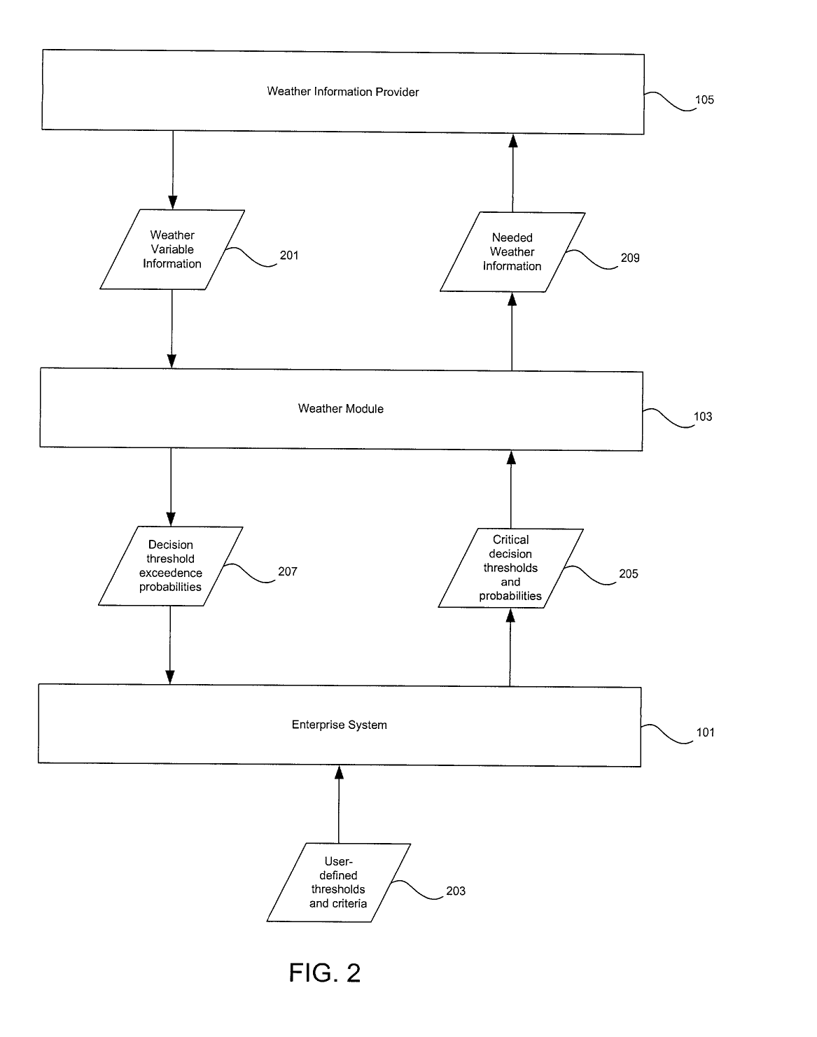

FIG. 2 shows a data flow diagram for data sent and received within the above-described architecture. Weather information provider 105 translates meteorological data into variables 201 that may be used in the weather module 103. Enterprise system 101 translates user-defined thresholds and probability criteria 203 for particular actions related to component business processes 113 (FIG. 1) into variables that may be used in the enterprise planning system. The enterprise system 101 then communicates information 205 to weather module 103, which analyzes the data provided and communicates results 207 of the analysis to enterprise planning system 101 in order to incorporate weather information into component business processes. The weather module 103 sends weather requests 209 to the weather information provider. Each weather request may be a one time request on an as needed basis, or it may be a request for types of information (precipitation amount, wind direction, wind speed, etc.) that the weather module should receive from the weather information provider on a continued basis. Alternatively, not shown, the enterprise system 101, instead of or in addition to the weather module 103, may send weather requests 209 to the weather information provider 105.

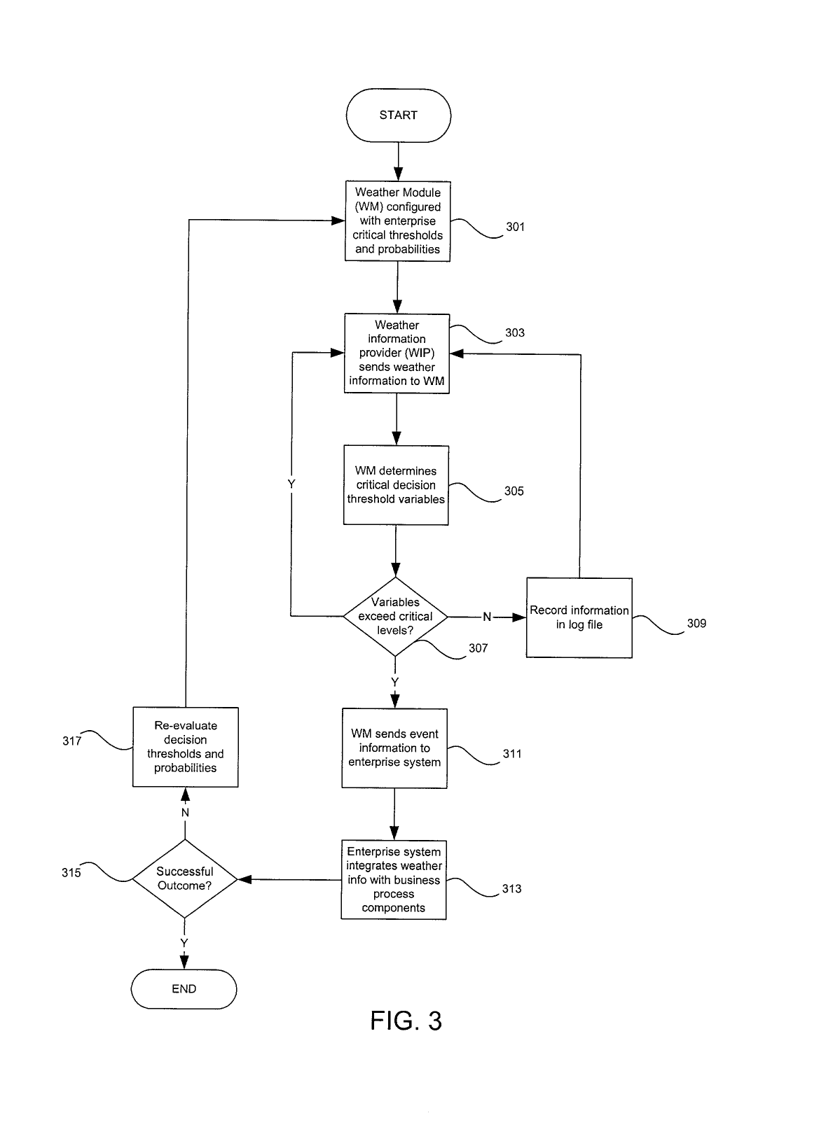

FIG. 3 shows a method for using the architecture to provide weather information to an enterprise system. In step 301, a weather module initially configures itself based on received enterprise critical decision thresholds and probabilities. One or more weather information providers send weather information to the weather module in step 303 based on a pre-arranged selection and schedule (e.g., hourly). The weather module translates and combines this information, in step 305, into critical decision threshold variables. The critical decision threshold variables are compared against pre-established critical levels, in step 307. If no critical threshold is exceeded, the weather module optionally logs such a result into a log file and continues monitoring received weather information in step 303.

However, if a critical threshold is exceeded, the weather module sends a notification to the enterprise system in step 311, and also continues monitoring received weather information in step 303. The notification may include information indicating that an event will or may occur and (optionally) the probability with which the event will or may occur. The enterprise system, in step 313, integrates this information with relevant business process system components to make an informed decision regarding the event. The enterprise system then checks to see whether the outcome of the informed decision is successful in step 315. If the decision is successful, the enterprise system processing of this event ends. However, if the decision is not successful, then the system (or a user operating the system) may re-evaluate the critical thresholds in step 317, and update them to the weather module in step 301, at which time the process starts over at step 301.

It should be appreciated by those skilled in the art that one or more of the above steps, such as step 309, may be optional, and that the steps may be performed in other than the above-described order. For instance, step 307 might not continue to step 303 upon a positive query. Instead, step 315 may continue to step 303 upon a positive query. Other alternatives are also possible.

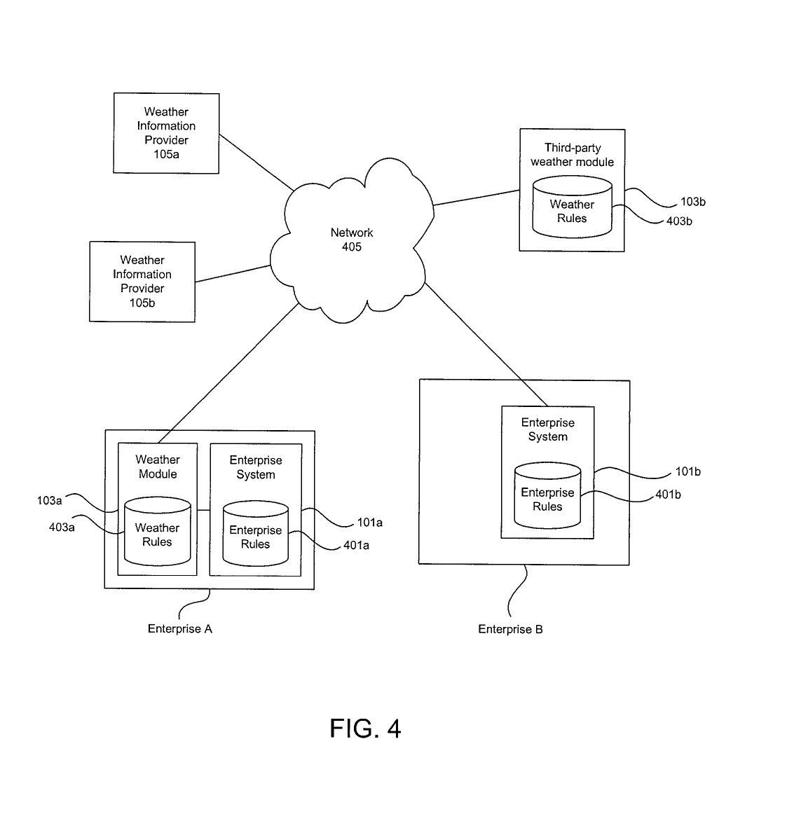

With reference to FIG. 4, a weather module 103a may be implemented as a component of an existing enterprise system 101a. The weather module 103a may include a weather rules database 403a, and the enterprise system may include business decision rules database 401a. Alternatively, a weather module 103b may be implemented by a third party, or by a weather information provider 105a, 105b. In this manner the weather module 103b may interface between systems of weather information provider 105a, 105b and enterprise system 101b that may not have been originally designed to interact. Communications between weather modules, enterprise systems, and weather information providers may occur across a network 405 such as the Internet, or any other computer network to which each is connected.

The weather module 103 may communicate information from weather information provider 105 to enterprise system 101 using information formatted according to the electronic data interchange (EDI) protocol. This data protocol may require, among other factors, that weather information provider 105 provide information on the accuracy of the meteorological or related data concomitant with the data itself. The data protocol may also require multiple weather information providers 105a, 105b to provide data in a predefined manner to all the weather modules 103a, 103b to integrate the weather information into a form suitable for incorporation into component business processes 113. The data protocol may also require quality control checks on the meteorological or related data according to thresholds or criteria set by the user in enterprise system 101. For example, the system may compare the accuracy of the weather information to the user's required threshold as indicated in a specific rule. The information on accuracy may also be translated by weather module 103 into variables relevant to component business processes 113 and communicated via EI layers 109a and 109b to enterprise system 101. In this manner, the enterprise system may use accuracy information independent of weather forecast information for decision rules based on accuracy and not forecast. For instance, the enterprise system may take into account in its decisions the fact that the weather forecast for a specific type of weather has a particularly low accuracy. The enterprise system may also use accuracy information to rate weather information providers when there is more than one weather information provider.

With respect to data provided by weather information provider 105a and 105b, certain information may be used by weather module 103a and 103b and/or enterprise system 101a and 101b in order to provide specific analysis. Relevant meteorological information should be on a time and geographic scale commensurate with the decision maker's (user's) needs. For example, when used with an airport flight scheduling system, meteorological information should be approximately centered on the airport (or airport flightpath(s)) with an appropriately sized radius so as to encompass the airport and its associated airspace. Meteorological information on a county or state-wide scale may be of little use to such a system. Additionally, the meteorological information should be provided on a schedule suitable to the user's needs. Providing only daily updates to the user (in this example, the airport or airline) may not be sufficient, while hourly updates might be.

Weather information is inherently uncertain in varying degrees. Accuracy can be measured using a wide range of techniques. Accuracy can refer to degree of correlation between the forecast and the event; it could also refer to the degree of improvement of the forecast over some naive baseline (e.g., climatology); it could refer to the probability of an event given the forecast; or it could refer to the probability of the forecast given the event, and other measures are possible. Weather information can be provided statically, e.g., via climatological data tables, for particular locations, or weather information may be provided dynamically at various time and spatial scales by government agencies (e.g., the U.S. National Weather Service) or by private enterprises (e.g., WeatherData Inc.). The information may have a degree of unreliability based on multiple information sources, inherent uncertainty bounds, or based on an empirical record of information uncertainty. Multiple information source conflicts may occur in a variety of situations. In addition to receiving conflicting reports from multiple weather information providers, multiple sources from within one weather information provider 105 may also provide conflicting reports. The conflicting reports from a single provider may occur when two weather prediction models are run with the same weather forecast data, or when a weather prediction model is run with two different sets of weather forecast data. Inherent uncertainty bounds may be produced based on model sensitivities. That is, weather forecasts are inherently uncertain. Finally, uncertainty may be based on an empirical record of information uncertainty. That is, the degree of uncertainty may be based at least in part on the actual historical inaccuracy of the weather information provided by the weather information provider(s).

Information from the weather information provider may be provided via transactional layers 111a and 111b to the enterprise planning system 101 in a manner that allows for integration with relevant component business processes 113. An empirical record of past information products provided by weather information provider 105 may be stored by the weather module 103 and a measure of uncertainty can be created independently by the weather module. Thus, data standards can be defined for weather information provider 105 for the timing and locational specificity of information that are provided. Data standards can also provide for measures of uncertainty; however, the weather module also contemplates creating such measures based on empirical performance. Depending upon the number of cases and other factors, determination of the accuracy itself may be an uncertain calculation. For example, hurricanes and tropical storms only on very rare occasions affect the coast of Southern California. The number of historical cases is so few that the empirical uncertainty (or error bars) in a 48 hour forecast of a category II hurricane striking Long Beach will be so large as to be meaningless for most users. There are other methods to determine uncertainty (e.g., using uncertainty estimate derived from Atlantic hurricanes) that may be appropriate.

The above-described principles may be better understood and illustrated through the following two examples.

In a first example, weather information may be integrated into an enterprise system used for airline flight scheduling. In such a system, the weather module may be initially configured with critical decision thresholds set by a user (the airline and/or airport) and the creation of a database of climatological information relevant to those decision thresholds. Critical decision thresholds for each airport may be a function of when airport operations change as a result of crossing certain weather thresholds. For example, decision variables that may be used in determining decision thresholds include crosswind runway restrictions, visibility and ceiling approach minimums, visibility and ceiling takeoff minimums, snow removal capacity, and airport operation capacity (i.e., maximum number of takeoffs or landings per hour when weather is not a factor). For each airport the selection of weather variables included in the database may be a function of the critical decision thresholds in use and the relationship of the weather variables to those thresholds. The following are examples of weather variables that may be related to the decision variables above: snow and sleet, freezing precipitation, ceiling, visibility, wind speed, wind direction, and thunderstorms. Other weather variables may also be used, as required by decision variables.

Decisions based on weather regarding the above variables may be made with respect to predictive meteorological information provided by a weather information provider and a climatological database. The climatological database may be at high spatial and temporal resolution, e.g., hourly data for 20 years. However, other resolutions may also be used.

The weather module may use information in the climatological database to calculate baseline probabilities of weather-related delays (and opportunities to avoid delays) as functions of the critical decision thresholds for a particular airport. For instance, with a climatological database of wind direction and wind speed, the weather module may calculate the expected probability of crosswind runway restrictions for specific parts of the day at specific times of the year, using known weather prediction principles. For example, if the average wind speed on a specific day of the year over a number of years is calculated, a baseline probability can be established indicating the likelihood that on a given day the wind speed will exceed a certain threshold. The weather module may also calculate average historical delays, as well as other statistical dimensions of the climatology, such as standard deviation.

A user may set a forecast time horizon, for instance five days, during which the system may use the meteorological information from the weather information provider as the sole source of information to calculate the weather-related probability of delays. Any amount of time may be selected by the user for the forecast time horizon, but in practice the accuracy of weather forecasts decreases as the forecast time horizon lengthens. The user may set this number according to required accuracies for decision-making, or based on any other requirement.

Beyond the forecast time horizon, the weather module may use the climatological database as the sole source of information to calculate the probability of weather events. However, it is also possible that the weather module uses the information provided by the weather information provider to predict whether a threshold is or may be exceeded within the forecast time horizon, and use information in the climatological database to help calculate the probability, or accuracy, of the prediction. The transition from using meteorological information to climatological information may be smooth, gradually increasing the weight of the climatological information and decreasing the weight of the meteorological information as the system transitions to a more distant time frame. Alternatively, the transition may be instant, where the system switches from meteorological information to climatological information for weather predictions beyond the forecast time horizon.

The weather module would not calculate independently created airline and/or airport delays such as scheduling past the capacity of the airport. Such delays may be determined by another component of an enterprise system and then communicated to the weather module to determine the interaction effects associated with these delays.

Within the forecast time horizon, the weather module may acquire actual weather information related to the relevant weather variables from a weather information provider. The weather information provider may provide a continuously updated stream (at a rate determined by the decision needs of the user's enterprise system) of meteorological information. The data stream may contain meteorological information, including information about the following example weather variables: snow, sleet, freezing precipitation, ceiling, visibility, wind speed, wind direction, thunderstorms, precipitation amount, weather radar forecast (e.g., one hour), cloud to ground lightning forecast (e.g., 30 min.), and forecast of an extreme event (i.e., a blizzard, tornado, etc.). The meteorological information may then be used by the weather module to determine whether any critical decision threshold is or may be exceeded within the forecast time horizon.

Each of these weather variables may be forecast in a probabilistic or categorical form. The weather module may maintain a historical record of categorical forecasts in order to generate accuracy statistics (e.g., which can then be translated into probabilistic information of the forecast) or receive such information from the weather information provider. Non-meteorological parameters may also be included. Non-meteorological parameters may include horticulture (i.e., extent of leaves on trees) and soil moisture (trees more likely to blow over in water-saturated soil). This historical record of categorical forecasts may be incorporated into the climatological database, or it may be maintained separately.

It is known that flight disruptions may occur if a sufficiently extreme event is forecast, regardless of whether the event actually occurs. For example, in February of 2001, many meteorologists forecast an “historic” blizzard in the northeastern United States. Many airlines cancelled their flights as a result of the forecast. The forecast overstated the storm's severity and were incorrect as to the timing of the blizzard. As a result, many flights were needlessly cancelled. In attempting to create a comprehensive overview of the effects of weather on airline operations, the module may provide the capability for a user to consider the effects on business operations of the forecasts of weather as well as of the weather itself.

The weather module manipulates the received data into enterprise relevant information. The weather module may translate the weather variables into two relevant data fields. First, the weather variables may be translated, and combined if necessary (e.g., wind speed and direction), into an event, i.e., into the units of the user's critical decision thresholds. Second, associated with the event may also be a probability of the event's occurrence. For example, wind speed of 20 knots and wind direction of NW (from the NW) may be combined into the event “North Wind Speed=14.14 knots.” That is, the north component of a 20 knot wind from the NW is 14.14 knots.

As an example, assume weather including light rain (wet runway), ceiling of 4,000 feet, and 6 mile visibility with winds of 40 knots from the north at Chicago O'Hare Airport. Also assume that this combination of weather phenomena leads airport operations decision makers to reduce O'Hare from seven operational runways to one. Capacity may then drop from 140 flights per hour to about 30. Capacity may again increase, however, if the wind speed (for instance) were to drop below 20 knots and from particular directions. In this situation the weather module may combine observed or predicted wind direction and wind speed in order to estimate when wind conditions would allow for a change in aircraft takeoff and landing operations. For example, some sample rules that may be used for the above scenario include the following:

| | |
|---|---|
| Sample Rule 1) | If north component of wind speed > 20 knots |
| | then crosswind limit exceeded = true. |
| Sample Rule 2) | If (visibility < 1 mile) and (ceiling < 3000 ft), |
| | then visibility limit exceeded = true. |
| Sample Rule 3) | If precipitation > 0″/hour, |
| | then wet runway = true. |
| Sample Rule 4) | If (crosswind limit exceeded or visibility limit exceeded) |
| | and wet runway, |
| | then close runway 27. |

In the above sample rules, wind speed, wind direction, visibility, ceiling, and precipitation are variables received from the weather information provider. The combination of these variables above certain threshold values are set by the user according to the requirements of weather sensitive decisions. Rules may apply to an entire airport, a single runway, or any other geographic area according to the user's needs. In addition, the weather information provider may place weather sensors in each specific region for which the user needs meteorological information, such as placing a wind gauge at or near each runway. In this manner the user may obtain weather information specific to individual areas of the enterprise for which the enterprise system is being used, without necessitating that a decision unnecessarily affect the entire enterprise. Rules may be implemented in a rule-based knowledge system (e.g., an expert system) or by other means.

Upon receiving weather information from the weather information provider the weather module may calculate when conditions would allow for a change in operations and with what probability, and communicate this to the enterprise system. The information provided by the weather module would thus serve as basic input to other component business processes of the enterprise system that depend in some fashion on the critical decision thresholds and probabilities related to weather information. For instance, when the crosswind limit has been exceeded for a runway, the enterprise system may automatically notify air traffic controllers not to clear planes to land on that runway.

An example of when an airline enterprise system may rely on probabilities would be when the wind speed fluctuates around the critical threshold wind speed. While the wind speed may often drop below the critical threshold speed, in this instance 20 knots from the north, the probability that the wind speed will remain below the critical threshold speed may be very low. As a result, the enterprise system may determine that flight capacity should not yet be increased. A rule in this case would incorporate hysteresis into the decision making process.

The above-described airline flight scheduling system may have wide applicability beyond decision making related to delays. For example, additional decisions may be made months ahead, days ahead, or minutes ahead of any given flight based on climatological information.

For example, assume that an airline wants to add a seasonal non-stop flight to Cancun. The airline may use the inventive system to determine which city (e.g., DEN or ORD) may be less likely to experience weather-related delays and what time of day would be less prone to weather problems in that season. This decision may be made months ahead of the intended start date of the new service, based on the climatological information.

As another example, assume that a package delivery company wants to add a package sorting hub in the central United States. It may learn that Denver is a better location than Wichita meteorologically, especially in spring and summer, because Denver's maximum frequency of thunderstorms is in the afternoon (slow time for cargo airlines) while Wichita's is in the evening and overnight hours (peak time).

Passengers may also benefit from the weather integrated enterprise system.

Assume a passenger wishes to travel from Wichita to Minneapolis. As there may be no non-stop service, the practical alternatives include changing planes in Denver, Chicago, St. Louis or Memphis. The prospective passenger may enter the time he/she wants to travel and learn the relative probabilities of a weather-related delay in each possible routing city. These probabilities may be calculated using known meteorological and climatological principles.

Passengers may also benefit from such a system the day before a flight. For example, upon logging onto an airline's web site, a passenger may view the expected probability of a flight delay through Chicago based on current, predicted, and historical weather information. Such information can be incorporated into an enterprise system for scheduling purposes or even to modify ticket prices in response to weather conditions. If there is a high likelihood of delay the passenger could attempt to re-route himself or herself through Denver on the way to Minneapolis. If the passenger is a top-tier member of the airline's frequent flier program, he may be flagged by the enterprise system for a telephone call from reservations and offered proactive rebooking if he had not rebooked himself.

Decisions may also be made the day before departure of a flight. For instance, the weather module, when meeting critical decision criteria for both event and probability (e.g. there is at least a 50% chance that crosswinds will exceed 20 knots), may communicate to the enterprise system that flight capacity at O'Hare airport the following day will be 650 flights (all airlines) versus 1200 which are scheduled. Users may then be in a position to proactively reschedule their flights to better accommodate the overload. Similarly, the weather module may automatically alert airport facilities (i.e., hotels, restaurants, etc.) that there is a high probability of flight cancellations and to plan accordingly (extra people, provisions, etc.).

The weather integrated enterprise system may also be helpful minutes before departure. Based on information from the weather information provider, the weather module may communicate to the enterprise system that lightning is moving in and its presence will likely exceed a critical decision threshold. Alerts may be sent to ground crews to cease refueling, and to baggage handlers to move indoors. Information may be simultaneously sent via the enterprise to flight dispatch, which posts any delayed flights and highlights incoming flights that are candidates for diversions. Similarly, information may be simultaneously sent via the enterprise system to the reservations computer system, which may generate pages, wireless web messages, or the like, to passengers and/or other designated contacts informing them of delay.

One feature of the system for the user (e.g., an airline or airline passenger) may be to set performance goals. For example, the user may decide to flag situations where there is a 60% chance or greater of improving one's flight routing to avoid weather-related delays and a 5% or less chance of a “backfire” (i.e., changing to a worse flight option). The performance goals may be set by each individual user. In response to the user-defined criteria, the system may examine the meteorological weather forecast (including accuracy) for each potential airport in conjunction with each airport's flight capacity in order to determine whether the user should reroute his or her flight while meeting the performance goals.

The weather integrated enterprise system may also be of assistance after the scheduled departure time. For instance, a customer relationship management system may send an e-mail to a predetermined destination indicating that the original flight was cancelled and that the passenger will not make it to his or her destination on time. This may be done for marketing reasons so that the customer trusts and values the system.

The system may also be used to evaluate the value of the weather information, e.g., as a function of various accuracies, in the context of comprehensive business operations. The user may thus have the ability to optimize decision routines (e.g., when to announce delays) and decision thresholds (e.g., according to specific probabilistic information) in such a fashion so as to capitalize on the information available from the weather information provider.

In a second example, an electric utility may benefit from the use of a weather integrated enterprise system. The weather module may be initially configured based on the establishment of critical decision thresholds set by a user (i.e. the electric utility) and the creation of a database of climatological information relevant to those decision thresholds. The critical decision thresholds for each utility may be a function of when decisions would be made as a result of one of the following (example) variables crossing a predetermined threshold: critical substation temperature, critical line temperature (i.e., line sag due to extreme heat), and critical pole and line wind speed with and without ice loading.

For each utility the selection of weather variables to include in the database may be a function of the critical decision thresholds and the relationship of the weather variables to those thresholds. The following examples are weather variables that may be related to the critical decision thresholds, above: snow, sleet and freezing precipitation and amounts (indicative of cold temperatures), temperature, wind speed, wind direction, thunderstorms or cloud to ground lightning frequency, composite reflectivity for thunderstorm-related outages, and radar VILs (vertically integrated liquid measure) for the three (or any other number) worst thunderstorm-related outages.

The weather information provider may provide a continuously updated stream of meteorological information comprising, for example, the weather variables above, as well as one or more of a weather radar forecast and publicly-available Storm Prediction Center (SPC) severe storm probabilities. The SPC is a U.S. government weather information provider in Norman, Okla. The meteorological information may then be used to make relevant weather predictions within the forecast time horizon, for example four days.

The weather module manipulates the received data into enterprise relevant information by translating the weather variables into an event and a probability of the event's occurrence. For example, assume a strong thunderstorm moves across Wichita, Kans. The storm has a footprint of 100 square miles and produces 200 cloud to ground lighting strikes per hour as it moves southeast at 35 knots (i.e., a major storm). Upon receiving weather information from the weather information provider, the weather module may calculate when conditions would allow for a change in operations, and with what probability, and communicate this to the enterprise system. This may be done using rules similar to the sample rules, below. The information provided by the weather module would thus serve as basic input to other component business processes of the enterprise system that depend in some fashion on the critical decision thresholds related to weather information.

The enterprise may then use this information to make advanced informed decisions based at least in part on weather information. For example, months ahead of a scheduled activity, in the present example, the utility company may use the information to schedule favorable times of the year to perform outdoor work (e.g., replace old utility wire poles, etc.), or the company may use the information to restrict the availability of vacation time during periods when there is a very high frequency and/or probability of severe weather.

The utility company may also use the information immediately in advance of inclement weather. For instance, assume that a weather information provider provides a forecast of strong storms for the next 24 hours. The weather module may translate and combine this information to result in an outcome of a 55% chance of damaging winds (50 knots or higher within 25 miles of a point). Assume further that this information, combined with independent forecasts (i.e. forecasts from multiple weather information providers) of a high probability of thunderstorms and high wind speeds between 4:00 and 7:00 P.M., exceeds a critical decision threshold. Thus, the weather module may communicate this information to the enterprise system, which is then in a position to alert schedulers of a high probability of outages. The enterprise system may then interact with other business process modules in order to schedule extra line crews, meals to be catered, extra people in an emergency call center, or extra public service advertising. The utility company may also use the weather information to estimate the extent of the potential outages, and to check inventory of replacement parts.

The enterprise system may also use the weather information to manage personnel immediately preceding inclement weather. For instance, the enterprise system, upon learning from the weather module that a storm will commence in approximately two hours, may allow the user (i.e., the utility company) to provide the repair crews a forty-five minute break in anticipation of needing the crews rested to perform repairs during and/or after the storm.

The enterprise system (through the weather module) may also use the weather information during inclement weather to compare a location of meteorological features provided by the weather information provider to actual reports of outages, communicated to the weather module via the enterprise system. The weather module may also interpolate between radar images and lightning strikes (using known meteorological techniques) after correlating outage reports to diagram areas where outages are most likely to have occurred, and the weather module may communicate the resulting information to assist dispatchers in getting crews to most seriously affected areas.

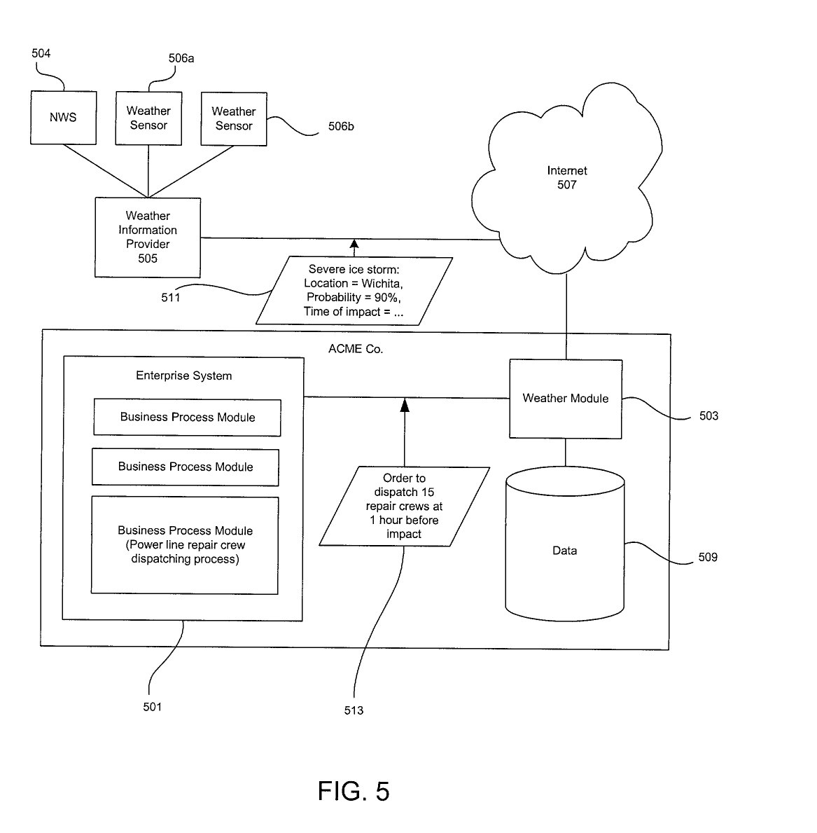

FIG. 5 shows an architecture and sample data flow that may be used to accomplish this second example. At an enterprise location there is an enterprise system 501 and a weather module 503. The weather module 503 includes critical threshold information database 509. The database 509 may include rules such as:

| | |
|---|---|
| Sample Rule 1) | If freezing precipitation > 2″/hour |
| | then ice storm = true. |
| Sample Rule 2) | If precipitation> 0″/hour and wind > 75 mph, |
| | then hurricane = true. |
| Sample Rule 3) | If (ice storm in Wichita with probability > 80%), |
| | then dispatch 15 repair crews 1 hour prior to impact. |
| Sample Rule 4) | If (ice storm in Wichita with probability > 20%), |
| | then dispatch 10 repair crews 1 hour prior to impact. |
| Sample Rule 5) | If (hurricane in Wichita with probability > 50%), |
| | then notify sister utility of need for additional manpower. |

In the above sample rules, precipitation and freezing precipitation are variables received from the weather information provider. Ice storm and hurricane are variables calculated by the weather module. Alternatively, ice storm and hurricane may also be variables received from the weather information provider. The probability requirements reflect the accuracy requirement of the forecast by the user (i.e., in this example, the utility company).

There is a weather information provider 505 that receives real time weather information from the National Weather Service 504, weather sensors 506a, 506b, or any other weather detection device. The weather module 503 receives meteorological information 511 from the weather information provider 505 through a network 507 such as the Internet. In this example, the weather information provider indicates that a severe ice storm will hit Wichita, Kans. at an estimated time. The weather module compares the information 511 to the rules in database 509 to determine whether any of the critical threshold levels are met or exceeded. If any levels are exceeded, the weather module sends event information 513 to the enterprise system 501. In this example, the event information may indicate that a severe ice storm is expected, and that the utility should dispatch repair crews at a specified time. It is assumed that enterprise system 501 includes business process modules that are sensitive to the events raised by weather module 503.

The enterprise system and weather module may also be configured to evaluate the value of the weather information, e.g., as a function of various accuracies, in the context of comprehensive business operations. The user may thus have the ability to optimize decision routines (e.g., when to schedule repair crews) and decision thresholds (e.g., according to specific probabilistic information) in such a fashion so as to capitalize on the information available from the weather information provider(s).

The above-described methods and systems may be embodied in computer readable instructions stored on one or more computer readable mediums, such as RAM, ROM, hard disks, removable storage devices, and the like.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A weather module for use with an enterprise system, comprising:
a processor, and
memory for storing computer readable instructions that, when executed by the processor, cause the weather module to perform the steps of:
(i) receiving meteorological data from a weather information provider;
(ii) receiving critical threshold information that relates a business process decision to one or more variables in the received meteorological data;
(iii) determining whether one of the critical thresholds is presently exceeded or is likely to be exceeded in the future; and
(iv) sending event information to the enterprise system to alter the business process decision when the one critical threshold is exceeded.

2. The module of claim 1, wherein the meteorological data comprises at least one of precipitation information, temperature information, and wind information.

3. The module of claim 1, further comprising a climatological database and wherein, in step (iii), within a forecast time horizon the module determines whether the one critical threshold is likely to be exceeded based on the meteorological information, and beyond the forecast time horizon the module determines whether the one critical threshold is likely to be exceeded based on climatological information stored in the climatological database.

4. The module of claim 3, wherein, as the forecast time horizon approaches, determinations are based on a combination of meteorological and climatological information.

5. The module of claim 1, wherein the critical threshold information comprises a critical level and a probability associated with the critical level.

6. The module of claim 5, wherein step (iii) determines whether the one critical level is likely to be exceeded in the future according to its associated probability.

7. The module of claim 1, wherein the critical threshold information is defined by a user of the enterprise system.

8. The module of claim 1, wherein the computer readable instructions further perform the step of transmitting to the weather information provider a request for meteorological information.

9. The module of claim 1, wherein the business process decision affects airplane flight operations.

10. The module of claim 1, wherein the business process decision affects electric utility operations.

11. The module of claim 1, wherein the critical threshold information corresponds to at least one of a runway crosswind level, a visibility level, and a cloud ceiling level.

12. The module of claim 1, wherein the critical threshold information corresponds to at least one of a critical substation temperature, critical utility line temperature, and a critical wind speed.

13. The module of claim 1, wherein the computer readable instructions further cause the module to perform the steps of:
(v) when, in step (iii), it is determined that a critical threshold level is exceeded or may be exceeded, determining a period of time for which the threshold will remain exceeded; and
(vi) sending delay information comprising the period of time to the enterprise system.

14. The module of claim 1, wherein the computer readable instructions further cause the module to perform the steps of:
(v) recording meteorological data in a historical weather database;
(vi) querying the historical weather database based on requested query data; and
(vii) sending query results to a query requester.

15. A method for integrating meteorological information into an enterprise system, comprising the steps of:
(i) receiving meteorological data from a weather information provider;
(ii) receiving critical threshold information that relates a business process decision to one or more variables in the received meteorological data;
(iii) determining whether one of the critical thresholds is presently exceeded or is likely to be exceeded in the future; and
(iv) sending event information to the enterprise system to alter the business process decision when the one critical threshold is exceeded.

16. The method of claim 15, wherein the meteorological data comprises at least one of precipitation information, temperature information, and wind information.

17. The method of claim 15, wherein, within a forecast time horizon step (iii) determines whether the one critical threshold is likely to be exceeded based on the meteorological information, and beyond the forecast time horizon step (iii) determines whether the one critical threshold is likely to be exceeded based on climatological information stored in a climatological database.

18. The method of claim 17, wherein, as the forecast time horizon approaches, determinations in step (iii) are based on a combination of meteorological and climatological information.

19. The method of claim 15, wherein the critical threshold information comprises a critical level and a probability associated with the critical level.

20. The method of claim 19, wherein step (iii) determines whether the one critical level is likely to be exceeded in the future according to its associated probability.

21. The method of claim 15, wherein the critical threshold information is defined by a user of the enterprise system.

22. The method of claim 15, further comprising the step of transmitting to the weather information provider a request for meteorological information.

23. The method of claim 15, wherein the business process decision affects airplane flight operations.

24. The method of claim 15, wherein the business process decision affects electric utility operations.

25. The method of claim 15, wherein the critical threshold information corresponds to at least one of a runway crosswind level, a visibility level, and a cloud ceiling level.

26. The method of claim 15, wherein the critical threshold information corresponds to at least one of a critical substation temperature, critical utility line temperature, and a critical wind speed.

27. The method of claim 15, further comprising the steps of:
(v) when, in step (iii), it is determined that a critical threshold level is exceeded or may be exceeded, determining a period of time for which the threshold will remain exceeded; and
(vi) sending delay information comprising the period of time to the enterprise system.

28. The method of claim 15, further comprising the steps of:
(v) recording meteorological data in a historical weather database;
(vi) querying the historical weather database based on requested query data; and
(vii) sending query results to a query requestor.

29. A computer readable medium comprising computer readable instructions for integrating meteorological information into an enterprise system, wherein when a processor executes the computer readable instructions, a data processing device performs the steps of:
(i) receiving meteorological data from a weather information provider;
(ii) receiving critical threshold information that relates a business process decision to one or more variables in the received meteorological data;
(iii) determining whether one of the critical thresholds is presently exceeded or is likely to be exceeded in the future; and
(iv) sending event information to the enterprise system to alter the business process decision when the one critical threshold is exceeded.

30. The computer readable medium of claim 29, wherein the meteorological data comprises at least one of precipitation information, temperature information, and wind information.

31. The computer readable medium of claim 29, wherein, within a forecast time horizon step (iii) determines whether the one critical threshold is likely to be exceeded based on the meteorological information, and beyond the forecast time horizon step (iii) determines whether the one critical threshold is likely to be exceeded based on climatological information stored in a climatological database.

32. The computer readable medium of claim 31, wherein, as the forecast time horizon approaches, determinations in step (iii) are based on a combination of meteorological and climatological information.

33. The computer readable medium of claim 29, wherein the critical threshold information comprises a critical level and a probability associated with the critical level.

34. The computer readable medium of claim 33, wherein step (iii) determines whether the one critical level is likely to be exceeded in the future according to its associated probability.

35. The computer readable medium of claim 29, wherein the critical threshold information is defined by a user of the enterprise system.

36. The computer readable medium of claim 29, wherein the computer readable instructions further comprise the step of transmitting to the weather information provider a request for meteorological information.

37. The computer readable medium of claim 29, wherein the business process decision affects airplane flight operations.

38. The computer readable medium of claim 29, wherein the business process decision affects electric utility operations.

39. The computer readable medium of claim 29, wherein the critical threshold information corresponds to at least one of a runway crosswind level, a visibility level, and a cloud ceiling level.

40. The computer readable medium of claim 29, wherein the critical threshold information corresponds to at least one of a critical substation temperature, critical utility line temperature, and a critical wind speed.

41. The computer readable medium of claim 29, wherein the computer readable instructions further comprise the steps of:
(v) when, in step (iii), it is determined that a critical threshold level is exceeded or may be exceeded, determining a period of time for which the threshold will remain exceeded; and
(vi) sending delay information comprising the period of time to the enterprise system.

42. The computer readable medium of claim 29, wherein the computer readable instructions further comprise the steps of:
(v) recording meteorological data in a historical weather database;
(vi) querying the historical weather database based on requested query data; and
(vii) sending query results to a query requester.

43. A business process decision system comprising:
a business process decision module; and
a weather module comprising:
a processor;
a stored critical threshold database for maintaining critical threshold information;
stored computer readable instructions that, when executed by the processor, cause the weather module to perform the steps of:
(i) transmitting to a weather information provider a request for meteorological data;
(ii) receiving meteorological data from the weather information provider;
(iii) receiving critical threshold information that relates a business process decision made by the business process decision module to one or more variables in the received meteorological data;
(iv) storing the critical threshold information in the critical threshold database;
(v) determining whether one of the critical thresholds is presently exceeded or is likely to be exceeded in the future; and
(vi) sending event information to the business process decision module to alter the business process decision when the one critical threshold is exceeded.

44. The system of claim 43, wherein the weather module further comprises a climatological database and wherein, in step (v), within a forecast time horizon the weather module determines whether the one critical threshold is likely to be exceeded based on the meteorological information, and beyond the forecast time horizon the weather module determines whether the one critical threshold is likely to be exceeded based on climatological information stored in the climatological database.

45. The system of claim 44, wherein, as the forecast time horizon approaches, determinations are based on a combination of meteorological and climatological information.

46. The system of claim 43, wherein the critical threshold information comprises a critical level and a probability associated with the critical level.

47. The system of claim 46, wherein step (v) determines whether the one critical level is likely to be exceeded in the future according to its associated probability.

48. The system of claim 43, wherein the computer readable instructions further cause the weather module to perform the steps of:
(vii) when step (v) determines that a critical threshold level is exceeded or may be exceeded, determining a period of time for which the threshold will remain exceeded; and
(viii) sending delay information comprising the period of time to the business process decision module.

49. The system of claim 43, wherein the computer readable instructions further cause the weather module to perform the steps of:
(vii) recording meteorological data in a historical weather database;
(viii) querying the historical weather database based on requested query data; and
(ix) sending query results to a query requestor.
